(19) United States
(12) Patent Application Publication
(10) Pub. No.: US 2011/0063261 A1
(43) Pub. Date: Mar. 17, 2011

(54) LIQUID CRYSTAL DISPLAY DEVICE INCLUDING IMPROVED CIRCUIT SUBSTRATE CONNECTION

(75) Inventors: Sung-Jae PARK, Seoul (KR); Ik-Sun SONG, Suwon-si (KR); Ki-Hong SONG, Cheonan-si (KR); Jin-Kyu PARK, Seoul (KR); Kyung-Ju JEON, Cheonan-si (KR); Hyeok-Tae KWON, Daegu (KR); Jun-Su KIM, Seoul (KR)

(73) Assignee: SAMSUNG ELECTRONICS CO., LTD., Suwon-si (KR)

(21) Appl. No.: 12/777,384

(22) Filed: May 11, 2010

(30) Foreign Application Priority Data
Sep. 11, 2009 (KR) 2009-0086065

(51) Int. Cl. G06F 3/038

(52) U.S. Cl. 345/204

(57) ABSTRACT

A display device includes; a display panel including; a data line, a gate line insulated from the data line and a pixel respectively connected to the data line and the gate line, a first printed circuit board (“PCB”) which drives the display panel and is disposed adjacent to the display panel, the first PCB having a first driving circuit disposed thereon, a second PCB disposed adjacent to the first PCB and the display panel, the second PCB having a second driving circuit and a control circuit disposed thereon, wherein the second driving circuit drives the display panel and the control circuit controls the first driving circuit and the second driving circuit.

This application claims priority to Korean Patent Application No. 2009-86065, filed on Sep. 11, 2009, the content of which in its entirety is herein incorporated by reference.

### BACKGROUND OF THE INVENTION

1. Field of the Invention

Exemplary embodiments of the present invention relate to a display device. More particularly, exemplary embodiments of the present invention relate to a display device having a printed circuit board (“PCB”) that allows for easy assembly thereof.

2. Description of the Related Art

Generally, a liquid crystal display (“LCD”) device includes an LCD panel, also referred to as a “display panel” for displaying images using light transmittance of liquid crystal molecules and a backlight assembly disposed below the LCD panel to provide the LCD panel with light for the operation thereof.

The LCD panel typically includes an array substrate having a plurality of pixel electrodes and a plurality of thin-film transistors (“TFTs”) electrically connected to the pixel electrodes, respectively, a color filter substrate having a common electrode and a plurality of color filters, and a liquid crystal layer interposed between the array substrate and the color filter substrate.

An alignment of liquid crystal molecules of the liquid crystal layer is varied by an electric field formed between the plurality of pixel electrodes respectively disposed in a plurality of pixels and the common electrode, so that transmittance of light through the liquid crystal layer may be altered thereby.

The LCD panel includes a control circuit substrate for driving the liquid crystal layer and a source circuit substrate electrically connected to the control circuit substrate.

FIG. 1 is a top plan view schematically illustrating a portion of an LCD device having a conventional single source circuit board. Referring to FIG. 1, the conventional LCD device includes an LCD panel 10, a source circuit substrate 20, a control circuit substrate 30, and a cable 40 for electrically connecting to the source circuit substrate 20 and the control circuit substrate 30. Moreover, the conventional LCD device includes a plurality of source chips on film (“COFs”) 50 electrically connected to the source circuit substrate 20 and the LCD panel 10.

The source COF 50 is electrically connected to the source circuit substrate 20 and a data line of the LCD panel 10. A source integrated circuit (“IC”) 51 is mounted on the source COF 50. A plurality of signal lines for transmitting digital video data and timing control signals, which are provided from the control circuit substrate 30, is formed on the source circuit substrate 20. Various control circuits, such as a data transmitting circuit, are mounted on the control circuit substrate 30. The source COF 50 and the source circuit substrate 20 are conventionally electrically connected to each other through an outer lead bonding (“OLB”) process.

FIG. 2 is a top plan view schematically illustrating a portion of a conventional LCD device having a conventional dual source circuit board. Referring to FIG. 2, the conventional LCD device includes an LCD panel 10, dual source circuit substrates 21 and 22, a control circuit substrate 30 and first and second flexible flat cables (“FFCs”) 41 and 42 for electrically connecting the dual source circuit substrates 21 and 22 and the control circuit substrate 30 in a manner similar to that illustrated with respect to the conventional LCD device as shown in FIG. 1. In the conventional arrangement illustrated in FIG. 2, the dual source circuit substrates 21 and 22 are mounted at a side surface of the LCD device.

However, as LCD devices have increased in size and a size of a case surrounding the LCD device has decreased, an overall size, and particularly a length, of a source circuit substrate is increased so that it is difficult to connect the source circuit substrate and a source COF. That is, equipment for performing the connecting operation can not easily connect the source circuit substrate having a predetermined length, for example, equal to or greater than about 540 mm and the source COF. Moreover, when the source circuit substrate has a length that is equal to or greater than a predetermined length, the source circuit substrate is typically divided into a plurality of individual source circuit substrates (similar to that illustrated in FIG. 2). However, in this case, the number of flexible flat cables is increased, so that a manufacturing time of each display is increased. In addition, a coupling error between the source circuit substrate and the source COF is increased. All of these aspects add to an undesirable increase in manufacturing costs.

### BRIEF SUMMARY OF THE INVENTION

Exemplary embodiments of the present invention provide a display device, or other form of display device, having a printed circuit board (“PCB”) for easy assembling thereof.

According to one exemplary embodiment of the present invention, a display device includes; a display panel including a data line, a gate line insulated from the data line and a pixel respectively connected to the data line and the gate line, a first PCB which drives the display panel and is disposed adjacent to the display panel, the first PCB having a first driving circuit disposed thereon and a second PCB disposed adjacent to the first PCB printed circuit board and the LCD display panel, the second PCB printed circuit board having a second driving circuit and a control circuit formed disposed thereon, wherein the second driving circuit driving drives the LCD display panel and the control circuit controlling controls the first driving circuit and the second driving circuit.

According to another exemplary embodiment of the present invention, a display device includes a display panel, a first PCB which drives the display panel and is disposed along a first axis of the display panel, the first printed circuit board having a first driving circuit formed thereon, a second PCB disposed along the first axis substantially in parallel with the first printed circuit board, the second printed circuit board having a second driving circuit and a control circuit disposed thereon, wherein the second driving circuit controls the display panel and the control circuit controls the first driving circuit and the second driving circuit and a third PCB which electrically connects the first printed circuit board and the second printed circuit board.

According to still another exemplary embodiment of the present invention, a display device includes a display panel including a data line, a gate line disposed substantially perpendicular to the data line and a pixel electrode electrically connected to the data line and the gate line, respectively, a first data circuit including at least one source driving circuit which provides at least a portion of the data line with image data, a source PCB disposed adjacent to the display panel, the source printed circuit board being connected to the first data circuit, a second data circuit including a source driving circuit which provides at least a portion of the data line with a data signal, a controller PCB adjacent to the LCD panel and the source printed circuit board, wherein the controller PCB is connected to the second data circuit and outputs a timing control signal which controls the first data circuit, the second data circuit and the image data and a connection substrate which electrically connects the source printed circuit board and the controller printed circuit board and transmits the image data and the timing control signal to the source printed circuit board.

According to some exemplary embodiments of the present invention, a single source PCB and a controller PCB are coupled with each other through a connection substrate, so that an assembly process may be simple and manufacturing cost may be reduced.

### BRIEF DESCRIPTION OF THE DRAWINGS

The above and other features and advantages of the present invention will become more apparent by describing in detailed example embodiments thereof with reference to the accompanying drawings, in which:

FIG. 1 is a top plan view schematically illustrating a portion of a conventional liquid crystal display (“LCD”) device having a conventional single source circuit board;

FIG. 2 is a top plan view schematically illustrating a portion of a conventional LCD device having a conventional dual source circuit board;

FIG. 3 is an exploded perspective view schematically illustrating an exemplary embodiment of an LCD device according to the present invention;

FIG. 4 is a top plan view showing an electrical connection relationship between a source circuit substrate and a controller substrate of the exemplary embodiment of an LCD device of FIG. 3;

FIG. 5 is a rear perspective view schematically illustrating a relationship between the source circuit substrate and the controller substrate of the exemplary embodiment of an LCD device of FIG. 3;

FIGS. 6A, 6B and 6C are top plan views illustrating an exemplary embodiment of a manufacturing process of a source circuit board and a controller substrate of the exemplary embodiment of an LCD device of FIG. 3;

FIG. 7 is a top plan view illustrating an exemplary embodiment of a connection method of a source circuit substrate and a controller substrate; and

FIG. 8 is a top plan view illustrating a source circuit substrate and a controller substrate of another exemplary embodiment of an LCD device according to the present invention.

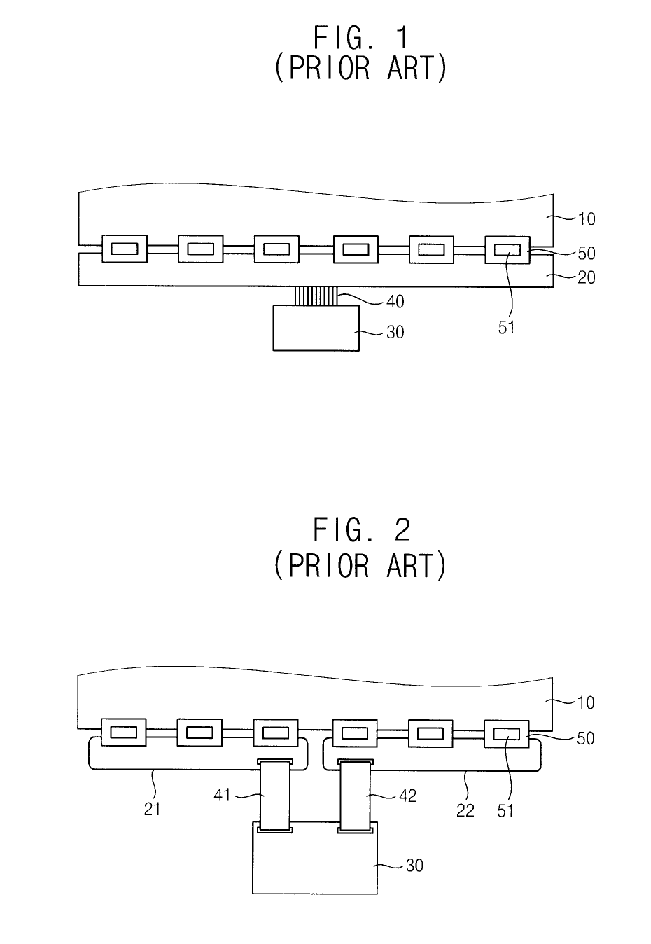

### DETAILED DESCRIPTION OF THE INVENTION

The present invention now will be described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. Like reference numerals refer to like elements throughout.

It will be understood that when an element or layer is referred to as being “on” another element, it can be directly on the other element or intervening elements may be present. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be explained in detail with reference to the accompanying drawings.

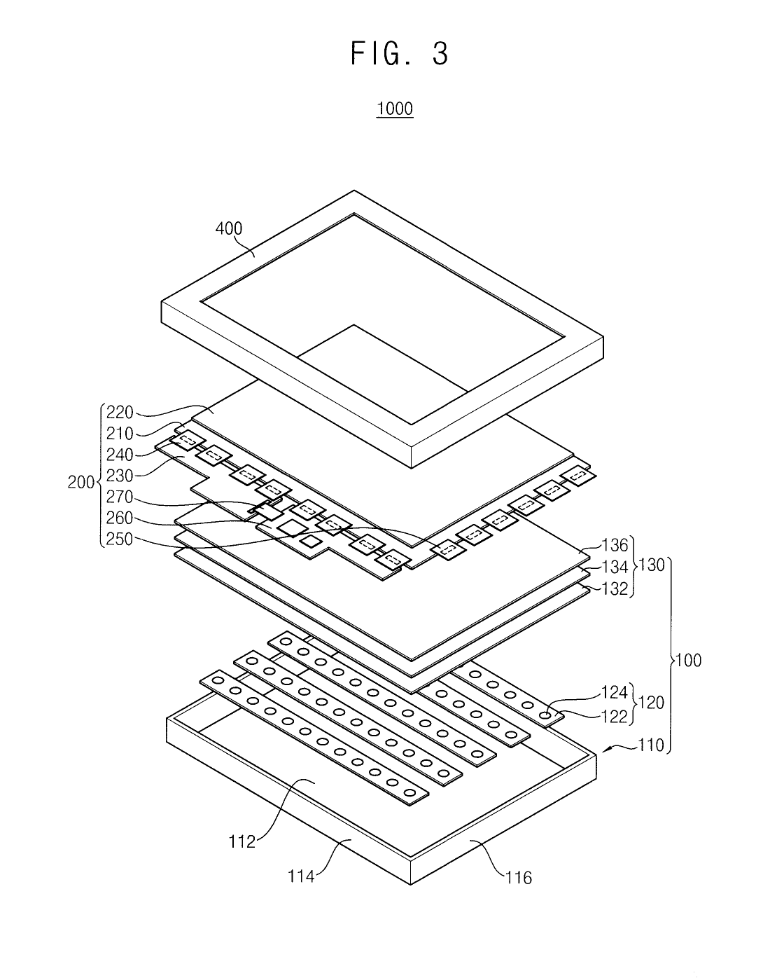

FIG. 3 is an exploded perspective view schematically illustrating an exemplary embodiment of a liquid crystal display (“LCD”) device according to the present invention.

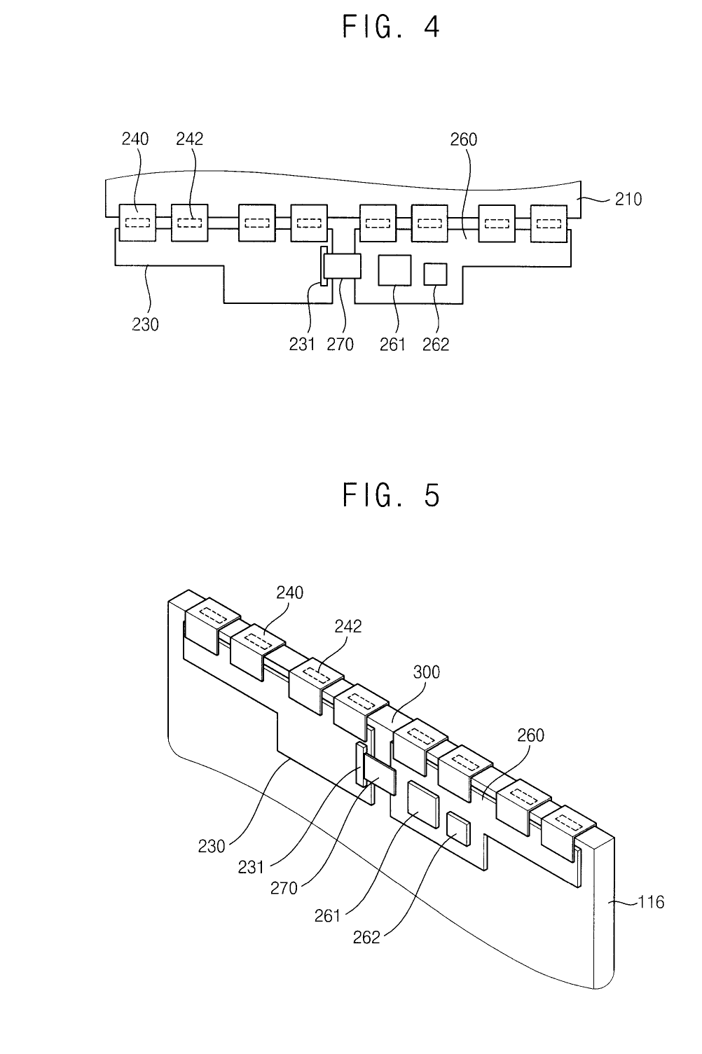

FIG. 4 is a top plan view showing an electrical connection relationship between a source circuit substrate and a controller substrate of the exemplary embodiment of an LCD device of FIG. 3. FIG. 5 is a rear perspective view schematically illustrating a relationship between the source circuit substrate and the controller substrate of the exemplary embodiment of an LCD device of FIG. 3. While an LCD device is described herein, the present invention is not limited thereto, and the principles disclosed herein may be applicable to other types of display devices, e.g., organic light emitting display devices, plasma display devices, etc.

Referring to FIGS. 3 to 5, an exemplary embodiment of an LCD device 1000 includes a backlight assembly 100, a display assembly 200 and a top chassis 400.

The backlight assembly 100 includes a receiving container 110, a light source 120 and an optical member 130.

The receiving container 110 includes a bottom portion 112 and a plurality of sidewalls 114 and 116 extended from a side surface of the bottom portion 112. Exemplary embodiments include configurations wherein the bottom portion 112 may have a substantially rectangular shape when viewed from a top plan view. The sidewalls 114 and 116 include a pair of long sidewalls 114 and a pair of short sidewalls 116. The long sidewalls 114 are formed at two end portions of the bottom portion 112 along a short axis direction thereof to be disposed substantially opposite to each other such that they extend in a substantially parallel direction. The short sidewalls 116 are formed at two end portions of the bottom portion 112 along a long axis direction thereof to be disposed substantially opposite to each other such that they extend in a substantially parallel direction, so that the short sidewalls 116 connect to corresponding side surfaces of the long sidewalls 114.

The light source 120 is received in the receiving container 110 to emit light therefrom towards the display assembly 200. In one exemplary embodiment, the light source 120 may include a light source driving part 122 and a light emitting diode (“LED”) 124 disposed on the light source driving part 122. In the illustrated exemplary embodiment, the light source driving parts 122 are extended along the long axis of the bottom portion 112 in parallel with one another. Alternative exemplary embodiments include configurations wherein the light source driving parts 122 may be disposed along the short axis of the bottom portion in parallel with each other. In one exemplary embodiment, the light source driving part 122 may have a rectangular shape. The light source driving parts 122 may be disposed in accordance with a size of the bottom portion 112. Alternative exemplary embodiments include configurations wherein alternative light sources and light source driving parts are utilized, e.g., the backlight assembly 100 may include a plurality of cold cathode fluorescent lamps (“CCFLs”) or various other light emitting devices. Alternative exemplary embodiments include configurations wherein the light source 120 may be disposed at a side of a transparent light-guide plate, which is sometimes referred to as an edge illumination type backlight assembly.

The light source driving part 122 provides the LED 124 with power. The LEDs 124 may be disposed on the light source driving part 122 along the long axis direction and substantially in parallel with each other. Alternative exemplary embodiments include configurations wherein the LEDs 124 may be disposed on a light source driving part 122 having a rectangular shape substantially in parallel with each other.

As described briefly above, the light source 120 may include an alternative light generating means besides the LED 124. For example, exemplary embodiments include configurations wherein the light source 120 may include one of a CCFL, a hot cathode fluorescent lamp (“HCFL”), an external electrode fluorescent lamp (“EEFL”), a surface light source and various other types of light source. In the present exemplary embodiment wherein an LED 124 is utilized in the backlight assembly 100, since the LED 124 emits a relatively large amount of heat as compared to other light generating means, the receiving container 110 may have a structure which is capable of effectively irradiating the waste thermal energy therefrom, e.g., radiating fins may be disposed on a rear side of the bottom portion 112.

The optical member 130 is disposed in the receiving container 110 to be positioned on the light source 120. The optical member 130 may enhance optical characteristics of light coming from the light source 120 such as luminance uniformity, a front luminance, etc. Exemplary embodiments of the optical member 130 may include a diffusion plate 132, a first prism sheet 134, a second prism sheet 136 and various other similar components. Alternative exemplary embodiments include configurations wherein the optical member 130 further includes additional optical sheets for providing the display assembly 200 with uniform light, and embodiments wherein one or more of the diffusion plate 132, the first prism sheet 134 and the second prism sheet 136 are omitted.

The display assembly 200 may include a liquid crystal display panel 210 and 220, a source circuit substrate 230, a source driving circuit 240, a gate driving circuit 250, a controller substrate 260 and a connection substrate 270. The display assembly 200 is disposed on the backlight assembly 100 to display images using light generated from the backlight assembly 100.

The display panel 210 and 220 may include a thin-film transistor (“TFT”) substrate 210, a color filter substrate 220 and a liquid crystal layer (not shown) interposed between the TFT substrate 210 and the color filter substrate 220. In one exemplary embodiment, the TFT substrate 210 includes a plurality of signal lines including a gate line (not shown) and a data line (not shown), a plurality of TFTs electrically connected to the plurality of signal lines, respectively, and a plurality of pixel electrodes electrically connected to the plurality of TFTs, respectively. The color filter substrate 220 is disposed substantially opposite to the TFT substrate 210. The color filter substrate 220 may include a common electrode receiving a common voltage and a plurality of color filters corresponding to the plurality of pixel electrodes, respectively. The liquid crystal layer (not shown) is interposed between the TFT substrate 210 and the color filter substrate 220. An alignment of liquid crystal molecules of the liquid crystal layer may be altered in response to an electric field formed between the plurality of pixel electrodes and the common electrode. Hereinafter, the TFT substrate 210 and the color filter substrate 220 will be referred as a display panel. Exemplary embodiments also include configurations wherein the color filters and/or the common electrode may be disposed on the TFT substrate 210.

The source circuit substrate, which in the present exemplary embodiment is, a first printed circuit board (“PCB”), 230 includes various circuits for driving the display panel 210 and 220. For example, in one exemplary embodiment the source circuit substrate 230 includes an electric element such as a capacitor, a resistor, etc., and a circuit for driving a source driving circuit 240 which is described below. A wiring forming the electric element and the circuit is formed on the source circuit substrate 230. In the exemplary embodiment illustrated in FIGS. 3-5, the source circuit substrate 230 has an L-shape. Since the source circuit substrate 230 has an L-shape, a larger number of source circuit substrates 230 may be manufactured from a single larger substrate (not shown), i.e., the shape of the source circuit substrate 230 may be optimized such that a large number of source circuit substrates 230 may be cut from a single larger substrate (not shown) without wasting portions of the larger substrate. In one exemplary embodiment, the source circuit substrate 230 is disposed on a rear surface of the receiving container 110. The source circuit substrate 230 provides a plurality of data lines with driving voltages for expressing a gradation by driving liquid crystal molecules through a TFT of the TFT substrate 210. Alternatively, the source circuit substrate 230 may have an I-shape.

The source circuit substrate 230 further includes a connector 231 for receiving a control signal that is transmitted from a control substrate 260 which is described below. The connector 231 may have a structure receiving a connection substrate 270 which is described below. For example, in one exemplary embodiment the connector 231 has a plurality of pins (not shown) connected to a wiring formed on the source circuit substrate 230 to have a socket structure surrounding each of the plurality of pins. An explanation concerning a structure of the connector 231 will be omitted as any of several arrangements well known to those of ordinary skill in the art may be utilized.

The source driving circuit 240 electrically connects the source circuit substrate 230 and the TFT substrate 210, so that the source driving circuit 240 may transmit a driving signal generated from the source circuit substrate 230 to the TFT substrate 210. The source driving circuit 240 may be bent, so that the source circuit substrate 230 may be disposed on an external surface of the receiving container 110 as illustrated in FIG. 5. In one exemplary embodiment, a driving chip 242 for driving the display panel 210 and 220 may be disposed on the source driving circuit 240. The source driving circuit 240 may have a tape carrier package (“TCP”) or a chip on film (“COF”) structure. In the TCP structure, the driving chip 242 is formed on a flexible film having a plurality of wirings formed thereon. Alternative exemplary embodiments include configurations wherein the driving chip 242 may be directly mounted on the TFT substrate 210, which is sometimes referred to as a chip on glass (“COG”) structure. In this case, a flexible printed circuit board (“FPCB”) on which a plurality of wirings is formed is disposed between the source circuit substrate 230 and the driving chip 242.

The gate driving circuit 250 transfers a gate signal for activating a TFT to a gate line. For example, in one exemplary embodiment the gate driving circuit 250 has amorphous silicon directly formed on the TFT substrate 210 when a plurality of TFTs is formed on a peripheral area of the TFT substrate 210. Hence, in one exemplary embodiment the gate driving circuit 250 may be simultaneously formed on the TFT substrate 210 when the TFTs are formed on the TFT substrate 210.

The controller substrate, which in the present exemplary embodiment is a second PCB, 260 receives an image signal from an external device (not shown) to generate a control signal for controlling the source circuit substrate 230.

The controller substrate 260 includes a digital driving circuit which receives an image signal from an external device (not shown) to deliver a digital image corresponding to each pixel to the source driving circuit 240. Moreover, the controller substrate 260 includes a system interface area and an internal data bus area. In the system interface area, the control signal is transmitted from an external device to the LCD panel 210 and 220 without further processing. In the internal data bus area, the image signals are processed to become suitable for driving the source driving circuit 240 and are then transmitted to the LCD panel 210 and 220.

Moreover, an analog driving circuit for driving the LCD panel 210 and 220 is formed on the controller substrate 260. For example, in one exemplary embodiment, the controller substrate 260 provides the source driving circuit 240, the gate driving circuit 250 and the LCD panel 210 and 220 with a reference voltage and power voltages. Moreover, the controller substrate 260 outputs a common voltage for application to a common electrode and a gamma voltage which is used as a reference voltage in a digital-analog converter (not shown) included in the source driving circuit 240.

In the present exemplary embodiment, the controller substrate 260 includes a timing controller 261 and a direct current-direct current (“DC-DC”) converter 262. The timing controller 261 generates a control signal for controlling the source circuit substrate 230 in response to an image signal. The DC-DC converter 262 generates direct voltages that are different from each other, which are used for driving the LCD panel 210 and 220 using a direct voltage input from an external device (not shown). Moreover, the controller substrate 260 may further include an electric element such as a capacitor, a resistor, etc., and a circuit for driving the source driving circuit 240.

Although not shown in FIGS. 3 to 5, the display assembly 200 may further include a connector that is electrically connected to an external graphic controller (not shown) to transmit an image signal to the timing controller 261. As illustrated in FIG. 5, the controller substrate 260 may be disposed at an exterior surface of the bottom portion 112 of the receiving container 110. For example, in one exemplary embodiment the controller substrate 260 may be disposed at an area adjacent to the source circuit substrate 230.

The connection substrate, which in the present exemplary embodiment is a third PCB, 270 electrically connects the controller substrate 260 and the source circuit substrate 230. The connection substrate 270 transmits a control signal generated from the controller substrate 260 to the source circuit substrate 230. The connection substrate 270 may include a flexible printed circuit board (“FPC”), a flexible flat cable (“FFC”) or various other similar devices. In the present exemplary embodiment, the connection substrate 270 is connected to the controller substrate 260 through an outer lead bonding (“OLB”) process. In the OLB process, the source driving circuit 240 is connected and attached to the controller substrate 260 via the application of heat and pressure using an anisotropic conductive film (“ACF”) as an interconnect material. The connection substrate 270 is inserted into the connector 231 using the pin-and-socket arrangement described above, so that the connector substrate 270 is electrically connected to the connector 231.

The top chassis 400 is disposed on the display assembly 200 to fix the display assembly 200 on the backlight assembly 100. For example, in one exemplary embodiment the top chassis 400 is coupled with sidewalls 114 and 116 of the receiving container 110, so that the display assembly 200 may be fixed to the backlight assembly 100. A portion of the top chassis 400 is opened to expose a display screen of the display panel 210 and 220.

In the present exemplary embodiment, although not shown in FIGS. 3 to 5, the receiving container 110 may have a structure which supports edge portions of the display panel 210 and 220 to fix the display panel 210 and 220 in place. As a result, in the present exemplary embodiment, an additional mold frame for supporting the edge portions of the display panel 210 and 220 may be omitted. Therefore, when the mold frame is omitted, heat generated from the light source 120 may be effectively irradiated toward an exterior of the LCD device through the receiving container 110.

Referring to again FIGS. 4 and 5, the source circuit substrate 230, the controller substrate 260 and the connection substrate 270 are continuously disposed along a length direction of the long sidewall 114. For example, in the exemplary embodiment illustrated in FIG. 5, the source circuit substrate 230, the connection substrate 270 and the controller substrate 260 are sequentially disposed along a length direction of the long sidewall 114. Alternative exemplary embodiments include configurations wherein the controller substrate 260, the connection substrate 270 and the source circuit substrate 230 may be sequentially disposed along a length direction of the long sidewall 114.

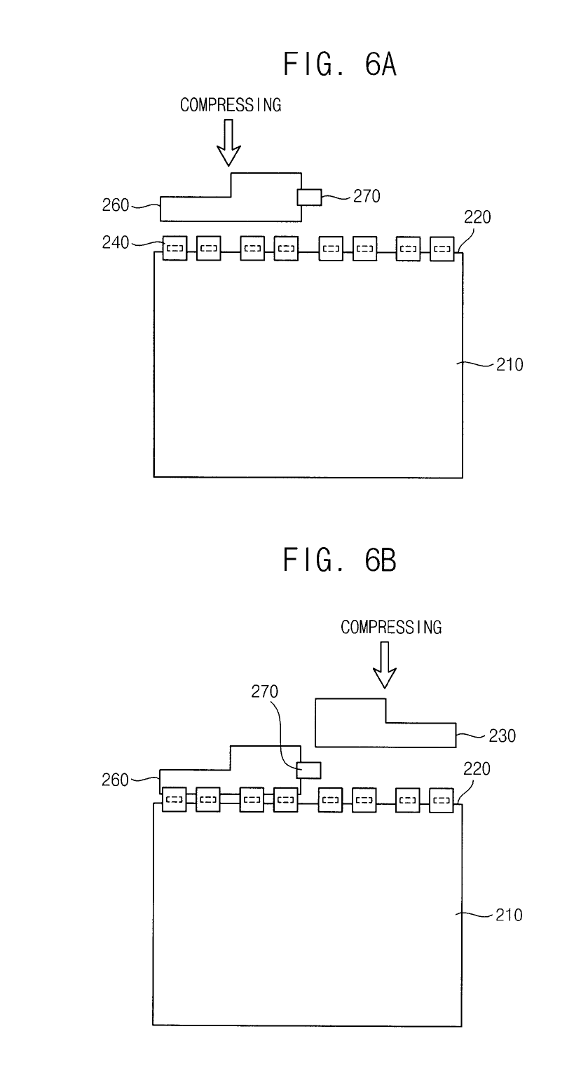

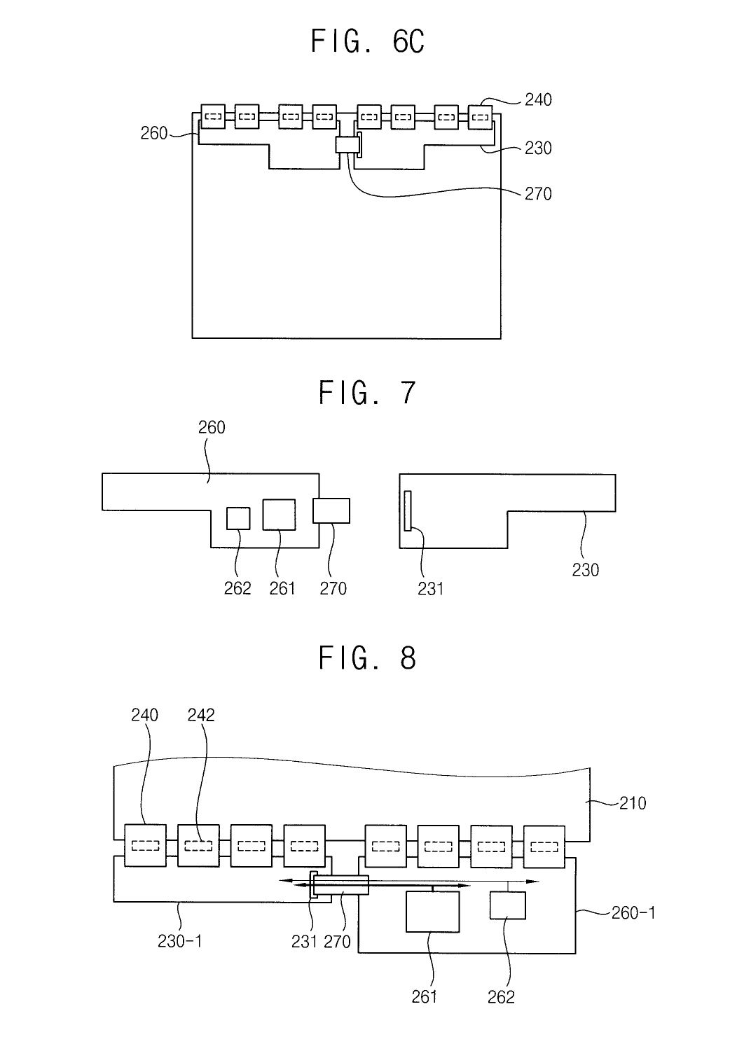

FIGS. 6A, 6B and 6C are top plan views illustrating an exemplary embodiment of a manufacturing process of a source circuit board and a controller substrate of the exemplary embodiment of an LCD device of FIG. 3. FIG. 7 is a top plan view illustrating an exemplary embodiment of a connection method of a source circuit substrate and a controller substrate.

In one exemplary embodiment, when manufacturing of the display panel 210 and 220 is completed, an OLB process for attaching the source driving circuit 240 for driving the display panel 210 and 220 is performed.

During the OLB process, the source driving circuit 240 is disposed on wirings formed on the display panel 210 and 220, for example, the TFT substrate 210, and then the source driving circuit 240 is compressed with the wirings at a suitable pressure and temperature.

Referring to FIG. 6A, when the OLB process is completed, a PCB process for attaching the controller substrate 260 to the source driving circuit 240 is performed. In the PCB process, an ACF (not shown) is disposed between the source driving circuit 240 and the controller substrate 260, and then heat and pressure are applied to form an electrical path between conductive particles of the ACF and electrodes of the source driving circuit 240 and/or the controller substrate 260. Then, sufficient heat is applied to the ACF, so that the source driving circuit 240 is adhered to the controller substrate 260. In one exemplary embodiment, before the PCB process is performed, the controller substrate 260 is electrically connected to the connection substrate 270. An explanation concerning a connection method between the controller substrate 260 and the connection substrate 270 is substantially the same as the connection method used in the LCD device, and a detailed description thereof will be omitted.

Then, referring to FIG. 6B, a PCB process for adhering the source circuit substrate 230 to the source driving circuit 240 is performed. At this time, as described above, the source circuit substrate 230 and the source driving circuit 240 are adhered to each other through the ACF, so that the source circuit substrate 230 and the source driving circuit 240 are electrically connected to each other via a PCB process similar to that described above. In one exemplary embodiment, before the PCB process is carried out for connecting the source driving circuit 240 and the source circuit substrate 230, the source circuit substrate 230 is electrically connected to the connector 231. An explanation concerning a connection method between the source circuit substrate 230 and the connector 231 is substantially the same as the connecting method used in the LCD device, so that a detailed description thereof will be omitted.

Referring to FIG. 6C, the source driving circuit 240 and the source circuit substrate 230 are connected to each other, and the source driving circuit 240 and the controller substrate 260 are connected to each other via the connection substrate 270 and the connector 231.

FIG. 7 illustrates the source circuit substrate 230, the controller substrate 260 and the connection substrate 270 in a state prior to connection. In one exemplary embodiment, when a connection between the source driving circuit 240 and the source circuit substrate 230 and a connection between the source driving circuit 240 and the controller substrate 260 are completed, the connection substrate 270 is connected to the connector 231.

According to a conventional art, at least two connection substrates have been required to connect two source circuit substrates and a control substrate, and at least two connecting operations have been performed by a worker during the manufacturing process, thus adding additional expense thereto. However, according to the present exemplary embodiment of the present invention, the source circuit substrate 230 and the control substrate 260 are connected to one connection substrate 270, so that one connecting operation may be performed by a worker, thus reducing the number of manufacturing steps and thereby decreasing manufacturing defects and costs. Thus, an assembling operation of worker may be simplified in comparison with the conventional assembling operation.

FIG. 8 is a top plan view illustrating another exemplary embodiment of a source circuit substrate and a controller substrate of another exemplary embodiment of an LCD device according to the present invention. The present exemplary embodiments of a source circuit substrate and a controller substrate are substantially the same as the source circuit substrate and the controller substrate of the previous exemplary embodiment except for the shapes thereof Thus, identical reference numerals are used in FIG. 8 to refer to components that are the same or similar to those shown in the previous exemplary embodiment, and thus a detailed description thereof will be omitted. In addition, conventional components of the exemplary embodiment of an LCD device except for the source circuit substrate and the controller are substantially the same as the elements of the previous exemplary embodiment, so that a detailed description thereof will be omitted.

Referring to FIG. 8, the present exemplary embodiment of an LCD device according to the present invention includes a source circuit substrate 230-1 and a controller substrate 260-1. In the present exemplary embodiment, the source circuit substrate 230-1 and the controller substrate 260-1 may have a quadrilateral shape, for example, a rectangular shape, although the present invention is not limited thereto. The source circuit substrate 230-1 is asymmetrical to the controller substrate 260-1. Thus, since the source circuit substrate 230-1 and the controller substrate 260-1 are asymmetric with each other, a driving circuit having various shapes but including at least a timing controller 261 and a DC-DC converter 262 may be mounted on the controller substrate 260-1. Moreover, in the present exemplary embodiment the controller substrate 260-1 is formed to have a larger size than the source circuit substrate 230-1, so that a connection between a connector (not shown) and a backlight driving circuit substrate (not shown) or a connection between the connection and an external power substrate (not shown) may be easy facilitated. In this case, the connector is formed on the controller substrate 260-1 to receive a signal and power from an external device.

According to the present invention, a single source circuit substrate and a controller substrate are connected to each other through a single connection substrate, so that an additional assembling process, which is required in a conventional art, may be simplified. In addition, a single connection substrate is used within an LCD device, so that manufacturing cost thereof may be reduced.

The foregoing is illustrative of the present invention and is not to be construed as limiting thereof Although a few exemplary embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. A display device, comprising:
a display panel comprising:
a data line;
a gate line insulated from the data line; and
a pixel respectively connected to the data line and the gate line;
a first printed circuit board which drives the display panel and is disposed adjacent to the display panel, the first printed circuit board having a first driving circuit disposed thereon; and
a second printed circuit board disposed adjacent to the first printed circuit board and the display panel, the second printed circuit board having a second driving circuit and a control circuit disposed thereon, wherein the second driving circuit drives the display panel and the control circuit controls the first driving circuit and the second driving circuit.

2. The display device of claim 1, further comprising a connection substrate which electrically connects the first printed circuit board and the second printed circuit board.

3. The display device of claim 2, wherein the connection substrate is a flexible printed circuit board.

4. The display device of claim 2, wherein the first printed circuit board comprises a plurality of driving circuits which transmit image data to the display panel.

5. The LCD device of claim 2, wherein the second printed circuit board comprises:
a timing controller which generates a timing control signal which controls the first printed circuit board; and
a direct current-direct current converter which supplies power to drive the display panel.

6. The display device of claim 1, wherein the first printed circuit board and the second printed circuit board are symmetric with each other.

7. The display device of claim 1, wherein the first printed circuit board and the second printed circuit board are asymmetric with each other.

8. The display device of claim 1, further comprising a source driving circuit connected to the first printed circuit board and the second printed circuit board to transmit image data to the display panel.

9. A display device comprising:
a display panel comprising a pixel;
a first printed circuit board which drives the display panel and is disposed along a first axis of the display panel, the first printed circuit board having a first driving circuit formed thereon;
a second printed circuit board disposed along the first axis substantially in parallel with the first printed circuit board, the second printed circuit board having a second driving circuit and a control circuit disposed thereon, wherein the second driving circuit controls the display panel and the control circuit controls the first driving circuit and the second driving circuit; and
a third printed circuit board which electrically connects the first printed circuit board and the second printed circuit board.

10. The display device of claim 9, wherein the first printed circuit board and the second printed circuit board are symmetric with each other.

11. The display device of claim 10, wherein the first printed circuit board comprises a plurality of driving circuits which transmit image data to the display panel.

12. The display device of claim 10, wherein the second printed circuit board comprises:
a timing controller which generates a timing control signal which controls the first printed circuit board; and
a direct current-direct current converter which supplies power to drive the display panel.

13. The display device of claim 9, wherein the first printed circuit board and the second printed circuit board are asymmetric with each other.

14. The display device of claim 9, further comprising a source driving circuit connected to the first printed circuit board and the second printed circuit board to transmit image data to the display panel.

15. A display device comprising:
a display panel comprising:
a data line;
a gate line disposed substantially perpendicular to the data line; and
a pixel electrode electrically connected to the data line and the gate line, respectively;
a first data circuit comprising at least one source driving circuit which provides at least a portion of the data line with image data;
a source printed circuit board disposed adjacent to the display panel, the source printed circuit board being connected to the first data circuit;
a second data circuit comprising a source driving circuit which provides at least a portion of the data line with a data signal;
a controller printed circuit board adjacent to the LCD panel and the source printed circuit board, wherein the controller PCB is connected to the second data circuit and outputs a timing control signal which controls the first data circuit, the second data circuit and the image data; and
a connection substrate which electrically connects the source printed circuit board and the controller printed circuit board and transmits the image data and the timing control signal to the source printed circuit board.

16. The display device of claim 15, wherein the source printed circuit board, the connection substrate and the controller printed circuit board are sequentially disposed in linear direction substantially parallel to a first axis of the display panel.

17. The display device of claim 16, wherein the source printed circuit board and the controller printed circuit board are symmetric with each other.

18. The display device of claim 17, further comprising a driving circuit which transmits image data to the display panel.

19. The display device of claim 17, wherein the controller printed circuit board comprises:
a timing controller which generates a timing control signal which controls the source printed circuit board; and
a direct current-direct current converter which supplies power to drive the display panel.

20. The display device of claim 16, wherein the source printed circuit board and the controller printed circuit board are asymmetric with each other.
